(19) United States
(12) Patent Application Publication
(10) Pub. No.: US 2023/0305502 A1
(43) Pub. Date: Sep. 28, 2023

(54) INTELLIGENT SWITCH

(71) Applicant: Chien-Chi WEN, Taichung City (TW)

(72) Inventor: Chien-Chi WEN, Taichung City (TW)

(21) Appl. No.: 17/702,162

(22) Filed: Mar. 23, 2022

(51) Int. Cl. G05B 15/02; H01H 9/02

(52) U.S. Cl. CPC G05B 15/02; H01H 9/02

(57) ABSTRACT

Disclosed is an intelligent switch for controlling a load configured on an AC system whether or not to obtain power for operation, and the load line and neutral wire of the AC system are connected to the load respectively. The intelligent switch includes a power-on unit, a remote controller and a load controller, wherein the power-on unit is used for connecting a live wire and the load line of the AC system, so as to control the circuit on/off of the live wire and the load line, and to supply DC to the remote controller, so that the remote controller accumulates electric energy for operation, the load controller is used for controlling the operation of the load, the remote controller is used for wireless remote control of the load controller, so as to control the load.

### CROSS-REFERENCE TO RELATED U.S. APPLICATIONS

Not applicable.

### BACKGROUND OF THE INVENTION

### 1. Field of the Invention

The present invention relates generally to a power switch for single live wire power-on, and more particularly to an innovative structure type of an intelligent switch.

### 2. Description of Related Art Including Information Disclosed Under 37 CFR 1.97 and 37 CFR 1.98

The single live wire power-on is a power supply control pattern of power supply operation of AC system for lamps or other electric appliances. In terms of the known single live wire switch, the L-phase input is connected to a power-on switch, the N-phase is connected to the load, and the L-phase output is connected to the power-on switch and the load. The L-phase input is generally known as the live wire, the N-phase is generally known as the neutral wire or zero conductor, and the L-phase output is generally known as the lamp wire or load line. The power-on switch can switch the circuit on/off between L-phase input and L-phase output, so as to control the load whether or not to obtain power for operation.

However, this structure type has the following problems according to practical experience: the power-on switch has bad inhibiting capacity for the input voltage variation through L-phase, so that the power supply voltage for the load is unstable, it is likely to have an adverse effect on the operation and service life of the load. The power-on switch controls the load to whether or not to obtain electricity for operation only by switching the circuit on/off, there is no other control on the load, for example, when the load is a lamp bulb, the power-on switch only controls the on/off of the bulb, it cannot control the light intensity or light color of the bulb.

### BRIEF SUMMARY OF THE INVENTION

The primary object of the present invention is to provide an intelligent switch. The technical problem to be solved is to break through how to develop a novel intelligent switch structure type with more ideal practicability.

Based on said purpose, the present invention provides an intelligent switch for controlling a load arranged in an AC system whether or not to obtain power for operation, and the load line and neutral wire of the AC system are connected to the load respectively. The intelligent switch includes a power-on unit, a remote controller and a load controller. The power-on unit is connected to a live wire and the load line of the AC system, so as to control the circuit on/off of the live wire and the load line, and to supply DC to the remote controller, so that the remote controller accumulates electric energy for operation. The load controller is used for controlling the operation of the load. The load controller is wirelessly connected to the remote controller. The remote controller is used for wireless remote control of the load controller, so as to control the load.

With the innovative structure type and technical characteristic, in comparison to prior art, the present invention can use the power-on unit to decide whether the load can obtain the electric energy for operation through the live wire or not, the safety during the repair or change of the load is enhanced. The power-on unit supplies electric energy to the remote controller, so that the remote controller can perform wireless remote control of the load controller to control the load to work or stop working, and to control the operation mode of the load to achieve practical progressiveness.

### BRIEF DESCRIPTION OF THE SEVERAL VIEWS OF THE DRAWINGS

FIG. 1 is the schematic diagram of configuration on AC system in the preferred embodiment of the present invention.

FIG. 2 is the circuit block diagram of power-on unit of the preferred embodiment of the present invention.

FIG. 3 is the circuit block diagram of remote controller of the preferred embodiment of the present invention.

FIG. 4 is the circuit block diagram of load controller of the preferred embodiment of the present invention.

FIG. 5 is the three-dimensional diagram of power-on unit of the preferred embodiment of the present invention.

FIG. 6 is the three-dimensional diagram of remote controller of the preferred embodiment of the present invention.

FIG. 7 is the three-dimensional diagram of the power-on unit disposed on the mounting base in the preferred embodiment of the present invention.

### DETAILED DESCRIPTION OF THE INVENTION

Please see the figures for the preferred embodiments of the intelligent switch of the present invention, but the embodiments are for illustration only, the patent application is not limited to this structure.

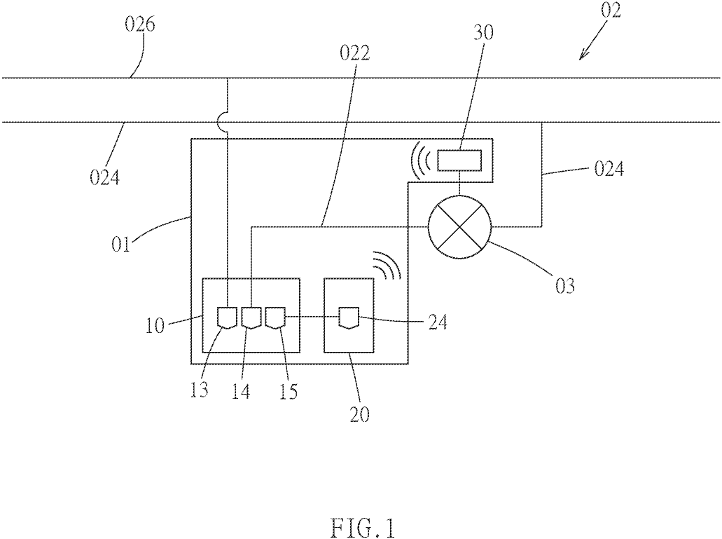

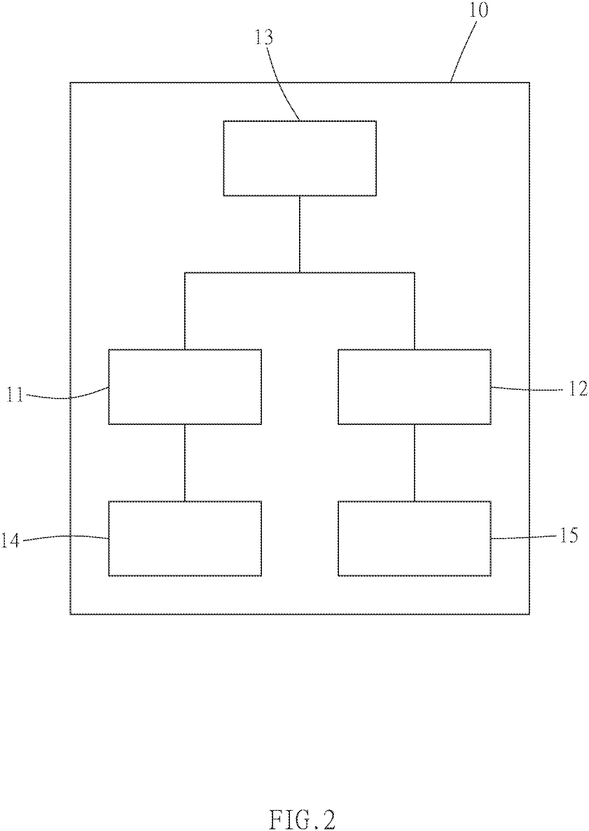

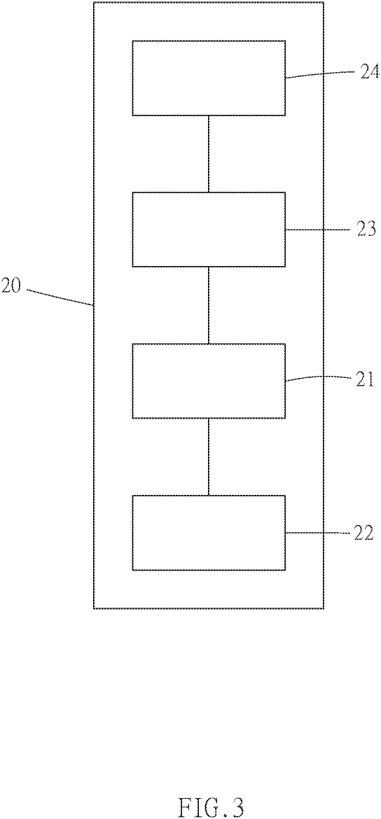

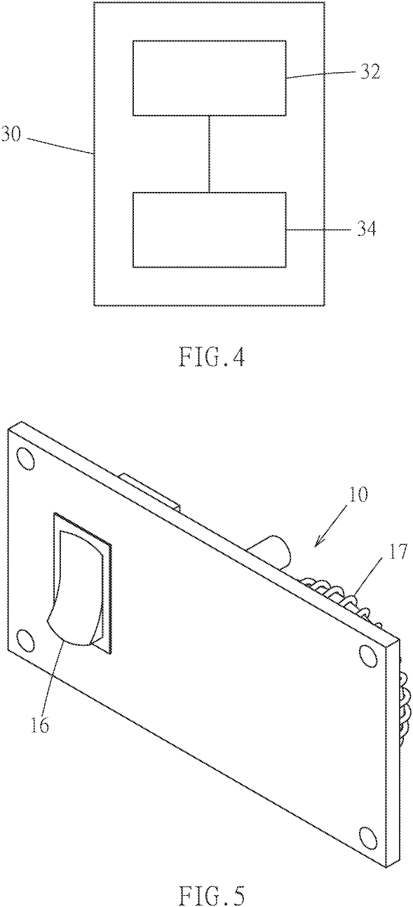

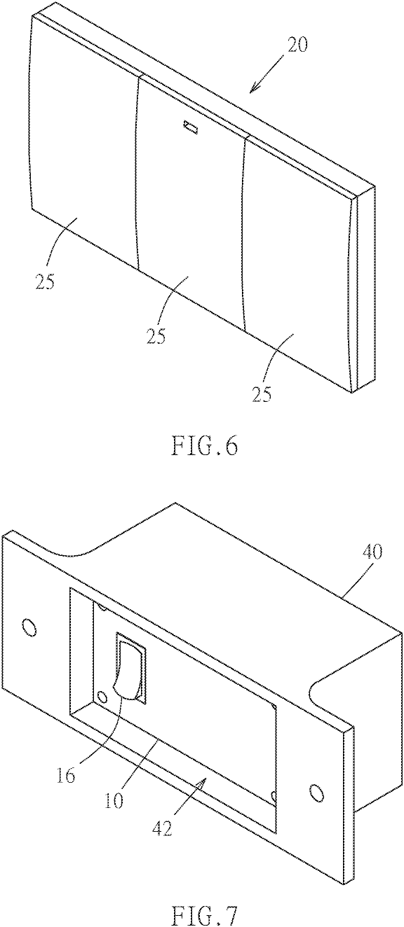

As shown in FIG. 1 to FIG. 7, said intelligent switch 01 controls a load 03 configured on AC system 02 whether or not to obtain power for operation, and the load line 022 and neutral wire 024 of the AC system 02 are connected to the load 03 respectively.

The intelligent switch 01 includes a power-on unit 10, a remote controller 20 and a load controller 30, wherein the power-on unit 10 is connected to a live wire 026 and the load line 022 of the AC system 02, so as to control the circuit on/off of the live wire 026 and the load line 022, and to supply DC to the remote controller 20, so that the remote controller 20 accumulates electric energy for operation. The load controller 30 is used for controlling the operation of the load 03. The load controller 30 is wirelessly connected to the remote controller 20. The remote controller 20 is used for wireless remote control of the load controller 30, so as to control the load 03.

The power-on unit 10 controls the circuit on/off of the live wire 026 and the load line 022, and decides whether the load 03 can obtain electric energy for operation through the live wire 026 or not. The power-on unit 10 supplies electric energy to the remote controller 20, so that the remote controller 20 accumulates electric energy for operation. The load controller 30 can be controlled wirelessly and remotely by operating the remote controller 20, so as to control the load 03.

To repair or change the load 03, the power-on unit 10 forms current interruption between the live wire 026 and the load line 022, the current cannot get in the load line 022 through the power-on unit 10. In this case, there will not be electric shock when repairing or changing the load 03, and the safety of repair or change of the load 03 is enhanced.

The remote controller 20 controls the load 03 in combination with the load controller 30. It not only controls the load 03 to work or stop working, but also controls the operation mode of the load 03. Taking a lamp as a specific example of the load 03, the on/off of the light can be controlled, and the light intensity and light color can be changed.

The power-on unit 10 includes a switch circuit 11, a rectification voltage transformation circuit 12, a first input port 13, a first output port 14 and a second output port 15. The switch circuit 11 and the rectification voltage transformation circuit 12 are connected in parallel. The switch circuit 11 and the rectification voltage transformation circuit 12 are electrically connected to the first input port 13 respectively. The switch circuit 11 is electrically connected to the first output port 14. The rectification voltage transformation circuit 12 is electrically connected to the second output port 15. The first input port 13 is used for connecting the live wire 026. The first output port 14 is used for connecting the load line 022, so that the switch circuit 11 switches the circuit on/off between the live wire 026 and the load line 022 to control the load 03 whether or not to obtain power. The rectification voltage transformation circuit 12 is used for rectifying and transforming the AC imported through the first input port 13 into DC, and exporting the DC to the second output port 15, so that the remote controller 20 accumulates electric energy. The switch circuit 11 has a first switch 16. The circuit on/off between the live wire 026 and the load line 022 can be switched by operating the first switch 16 manually.

The switch circuit 11 has an inductive component 17. The inductive component 17 is used for stabilizing the voltage of the current transferred from the switch circuit 11 to the first output port 14. Hereby, the inductive component 17 forms an inhibitory effect on voltage variation, and the power-on unit 10 supplies voltage stabilized electric energy to the load 03, so that the operational reliability and service life of the load 03 are enhanced.

The remote controller 20 includes a first control loop 21, a wireless signal emission circuit 22, an electric power storage unit 23 and a second input port 24. The electric power storage unit 23 is a secondary battery which can be charged and discharged many times. The electric power storage unit 23 can be replaced by a capacitor or other chargeable or dischargeable electronic modules or electronic circuits. The electric power storage unit 23 is electrically connected to the first control loop 21 and the second input port 24 so that the power-on unit 10 is connected to the second input port 24 through the second output port 15 to charge the electric power storage unit 23. The electric power storage unit 23 accumulates electric energy for the operation of the remote controller 20. The first control loop 21 is electrically connected to the wireless signal emission circuit 22. The first control loop 21 has several second switches 25. Hereby, the second switches 25 are operated to make the first control loop 21 emit control signals to the outside through the wireless signal emission circuit 22. The quantity of the second switches 25 can be changed as required, but there shall be at least one of the second switches 25.

The first switch 16 and the second switch 25 can be mechanical switch or electronic switch as required, wherein the specific examples of the mechanical switch include, but not limited to rocker type, sliding type, press type and toggle type.

The load controller 30 includes a second control loop 32 and a wireless signal receiving circuit 34, wherein the second control loop 32 is electrically connected to the wireless signal receiving circuit 34. The wireless signal receiving circuit 34 is used for receiving the control signal. The second control loop 32 transfers the corresponding control signal to the load 03 based on the control signal, so that the load controller 30 controls the operation of the load 03.

The control signal can be transmitted through any wireless transmission form of NFC, RF2.4G, Zigbee, infrared, Bluetooth, Wi-Fi and Z-Wave between the wireless signal emission circuit 22 and the wireless signal receiving circuit 34.

The preferred embodiment includes a mounting base 40, wherein the mounting base 40 is used for fixing the box-like structure fixed in the wall. An accommodation space 42 is formed inside the mounting base 40. The accommodation space 42 is open to the outside toward the front side of the mounting base 40. The power-on unit 10 is disposed in the accommodation space 42. Hereby the power-on unit 10 is located, the remote controller 20 is removably arranged in the accommodation space 42, and the remote controller 20 is located on the front side of the power-on unit 10. Hereby the remote controller 20 is connected to the power-on unit 10, when the power-on unit 10 charges the electric power storage unit 23, the remote controller 20 can be disposed on the mounting base 40.

I claim:

1. An intelligent switch for controlling a load configured on an AC system whether or not to obtain power for operation, and the load line and neutral wire of the AC system are connected to the load respectively;
the intelligent switch includes a power-on unit, a remote controller and a load controller, wherein the power-on unit is connected to a live wire and the load line of the AC system, so as to control the circuit on/off of the live wire and the load line, and to supply DC to the remote controller, so that the remote controller accumulates electric energy for operation, the load controller is used for controlling the operation of the load, the load controller is wirelessly connected to the remote controller, the remote controller is used for wireless remote control of the load controller, so as to control the load.

2. The intelligent switch defined in claim 1, wherein:
the power-on unit includes a switch circuit, a rectification voltage transformation circuit, a first input port, a first output port and a second output port, wherein the switch circuit and the rectification voltage transformation circuit are connected in parallel, the switch circuit and the rectification voltage transformation circuit are electrically connected to the first input port respectively, the switch circuit is electrically connected to the first output port, the rectification voltage transformation circuit is electrically connected to the second output port, the first input port is used for connecting the live wire, the first output port is used for connecting the load line, so that the switch circuit switches the circuit on/off between the live wire and the load line to control the load whether or not to obtain power; the rectification voltage transformation circuit is used for rectifying and transforming the AC imported through the first input port into DC, and exporting the DC to the second output port, so that the remote controller accumulates electric energy; the switch circuit has a first switch for switching the circuit on/off between the live wire and the load line by manual operation;
the remote controller includes a first control loop, a wireless signal emission circuit, an electric power storage unit and a second input port, wherein the electric power storage unit is electrically connected to the first control loop and the second input port, so that the power-on unit is connected to the second input port through the second output port to charge the electric power storage unit, the electric power storage unit accumulates electric energy for the operation of the remote controller, the first control loop is electrically connected to the wireless signal emission circuit, the first control loop has at least one second switch, hereby, the second switch is operated to make the first control loop emit control signals to the outside through the wireless signal emission circuit;
the load controller includes a second control loop and a wireless signal receiving circuit, wherein the second control loop is electrically connected to the wireless signal receiving circuit, the wireless signal receiving circuit is used for receiving the control signal, the second control loop transfers the corresponding control signal to the load based on the control signal, so that the load controller controls the operation of the load.

3. The intelligent switch defined in claim 2, wherein the switch circuit has an inductive component, the inductive component is used for stabilizing the voltage of the current transferred from the switch circuit to the first output port.

4. The intelligent switch defined in claim 1, including a mounting base, wherein the mounting base is used for fixing the box-like structure fixed in the wall, an accommodation space is formed inside the mounting base, the accommodation space is open to the outside towards the front side of the mounting base, the power-on unit is disposed in the accommodation space, hereby the power-on unit is located.
